(19) United States
(12) Patent Application Publication
(10) Pub. No.: US 2002/0131756 A1
(43) Pub. Date: Sep. 19, 2002

(54) Variable optical attenuator

(76) Inventor: Henry Hung, Paradise Valley, AZ (US)

Correspondence Address: DONALD J. LENKSZUS, P.C., P.O. Box 3064, Carefree, AZ, 85377-3064, US

(21) Appl. No.: 09/811,992

(22) Filed: Mar. 19, 2001

Related U.S. Application Data
(60) Provisional application No. 60/240,623, filed on Oct. 16, 2000.

(51) Int. Cl. G02B 6/26

(52) U.S. Cl. 385/140; 385/15

(57) ABSTRACT

A variable optical reflector/attenuator includes an optical coupler having first, second, third and fourth ports, the first port receives input optical signals, the fourth port provides output signals. A loop of optical fiber is coupled between the third and fourth ports. A non-reciprocal phase shifter is disposed in the loop. The non-reciprocal phase shifter is operable to provide a non-reciprocal phase shift variable from a first predetermined phase shift to a second predetermined phase shift, to control the amount of light received at thed first port that is coupled to the output port and the amount of light reflected to the first port.

### FIELD OF THE INVENTION

This invention pertains to optical systems, in general, and to variable optical attenuators and reflectors for use in optical systems, in particular.

### BACKGROUND OF THE INVENTION

There are many applications in optical systems where a variable optical attenuator or reflector is desirable. The present invention provides a variable optical attenuator in which a non-reciprocal phase shifter is utilized.

A non-reciprocal phase shifter introduces a predetermined phase shift into an optical signal propagating in one direction and a different predetermined phase shift into an optical signal propagating in the opposite direction. In some instances, the magnitude of the phase shift in both directions is the same, but the shifts are of opposite sign.

Non-reciprocal phase shift is based on the principle of Faraday rotation. With Faraday rotation, the angle of rotation is defined as θ=vBl. B is the magnetic flux density, v is the constant of proportionality known as the Verdet constant, and l is the length of the crystal. The Verdet constant is a measure of a crystal's ability to rotate the plane of polarization of optical signals. The direction of rotation depends on whether light propagation is parallel or anti-parallel to the magnetic flux density.

Applications of Faraday rotation include optical isolators and circulators. An optical isolator prevents or reduces the backward reflected light. A circulator directs light from one port to the next only one way. Both isolators and circulators are non-reciprocal devices. Most applications use 45 degrees rotation, which is achieved by using bulk crystals such as Yttrium Iron Garnet (YIG) or thin film crystals such as Bismuth Iron Garnet (BIG). The thickness, l, of a crystal is selected to provide 45 degrees rotation in a saturating magnetic field.

Typical Faraday rotation of a crystal as a function of the magnetic field follows a hysteresis loop extending from −45 degrees to +45 degrees. With the crystal length, l, cut for 45 degrees rotation, the state of polarization is well defined when a saturating magnetic field is applied to the crystal in either direction. However, in a zero magnetic field, and at in between saturations, the rotation is not defined.

### SUMMARY OF THE INVENTION

In accordance with the principles of the invention, avariable optical reflector/attenuator includes an optical coupler having first, second, third and fourth ports, the first port receives input optical signals, the fourth port provides output signals. A loop of optical fiber is coupled between the third and fourth ports. A non-reciprocal phase shifter is disposed in the loop. The non-reciprocal phase shifter is operable to provide a non-reciprocal phase shift variable from a first predetermined phase shift to a second predetermined phase shift, to control the amount of light received at the first port that is coupled to the output port and the amount of light reflected to the first port.

A variable optical reflector/attenuator in accordance with the invention has a full range of adjustment of up to 40 dB. It further has a low insertion loss of 1dB and can provide switching at fast speeds. It has no moving parts and accordingly is highly reliable.

### BRIEF DESCRIPTION OF THE DRAWING

The invention will be better understood from a reading of the following detailed description in conjunction with the drawing figures in which like reference indicators are used to identify like elements, and in which:

FIG. 1 is a cross-section of a non-reciprocal phase shifter in accordance with the invention;

FIG. 2 is a cross-section of a second non-reciprocal phase shifter in accordance with the invention.

FIG. 3 is a block representation of a variable optical attenuator in accordance with the principles of the invention;

FIG. 4 is a representation of a Sagnac Interferometer used as a fixed loop reflector in accordance with the invention;

FIG. 5 illustrates a variable optical reflector/attenuator in accordance with the principles of the invention;

FIG. 6 illustrates one embodiment of a variable optical reflector/attenuator in accordance with the principles of the invention;

FIG. 7 illustrates another variable optical reflector/attenuator in accordance with the invention;

FIG. 8 illustrates a further variable optical reflector/attenuator in accordance with the invention;

FIG. 9 is block diagram of a variable optical attenuator in accordance with the principles of the invention; and

FIG. 10 illustrates a portion of the variable optical attenuator of FIG. 9 in greater detail.

### DETAILED DESCRIPTION

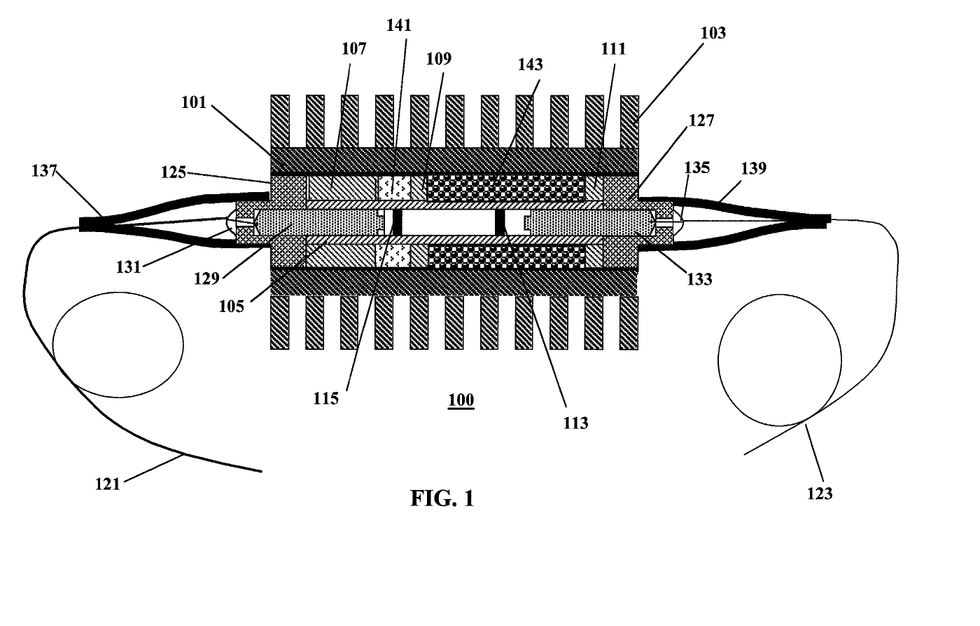

FIG. 1 illustrates a first embodiment of a non-reciprocal phase shifter (NRPS) 100 in accordance with the invention. NRPS 100 is a hermetically sealed unit that includes tubular aluminum housing 101 that has a plurality of heat radiating fins 103 disposed on its outer surface. An inner support sleeve or tube 105 is positioned concentric with housing 101. Tube 105 is also of aluminum in the illustrative embodiment. Support washers 107, 109, 111, support tube 105 within housing 101. Disposed within tube 105 are two magneto-optic Faraday rotation devices that are thin film BIG crystals 113, 115 Optical signals are coupled to and from the non-reciprocal phase shifter 100 via optical waveguides 121, 123, which in the particular embodiment shown are optical fiber. However, in other embodiments, one or both of the waveguides 121, 123 may be waveguides formed on a substrate and the non-reciprocal phase shifter may be formed on the substrate also as an integrated optic device. Optical fiber 121 extends through a housing cap washer 125 to couple to collimator 129. Epoxy 131 is used to bond fiber 121 in place. Similarly, optical fiber 123 extends through hosing cap washer 127 to couple to collimator 133. Epoxy 135 is used to bond fiber 123 in place. Boots 137, 139 are positioned on each housing cap washer 125, 127, respectively to support fibers 121, 123.

A ring shaped permanent magnet 141 is positioned concentric with BIG crystal 113. An electromagnet 143 is disposed proximate BIG crystal 115. Electromagnet 143 is formed by a wire coil.

In operation, crystal 115 is fixed at a predetermined rotation angle and crystal 113 is switched from a second predetermined rotation angle to a third predetermined rotation angle to provide for switching of NRPS 100. In the illustrative embodiment of the invention, permanent magnet 141 biases crystal 115 to either +45 degrees or −45 degrees of rotation. Electromagnet 143 switches its magnetic polarity to switch the Faraday rotation in crystal 113 between +45 degrees and −45 degrees. The combined result is that switching the magnetic polarity of electromagnet 143 produces a 0 to 90 degree phase shift.

The non-reciprocal phase shifter 100 of FIG. 1 is simply assembled, with construction similar to that of optical isolators. Advantageously, non-reciprocal phase shifter 100 provides low insertion loss of 1 dB or less, low cost and small size. More specifically the device of FIG. 1 is 48 mm in length and has an outside diameter of 10 mm without fins 103. With elliptical fins 103, the outside diameter is 28 mm×16 mm.

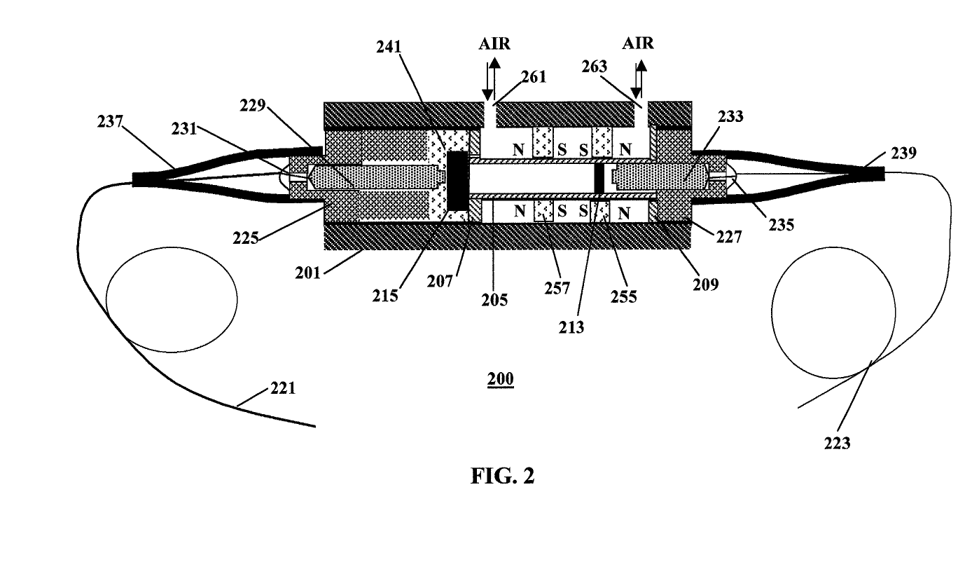

FIG. 2 illustrates a second non-reciprocal phase shifter 200 in accordance with the principles of the invention. Non-reciprocal phase shifter 200 differs in operation from non-reciprocal phase shifter 100 in that it utilizes a pair of permanent magnets in place of the electromagnet of the structure of FIG. 1.

NRPS 200 is a hermetically sealed unit that includes tubular aluminum housing 201. Because no heat generating components are included in NRPS 200, heat dissipating fins are not needed. An inner support sleeve or tube 205 is positioned concentric with housing 201. Tube 205 is also of aluminum in the illustrative embodiment. Support washers 107, 109 support tube 105 within housing 101. Disposed within tube 105 are two magneto-optic Faraday rotation device, i.e., thin film BIG crystals 213, 215. Crystal 215 is supported at one end of tube 205, and crystal 213 is disposed within tube 205. Optical signals are coupled to and from the non-reciprocal phase shifter 200 via optical waveguides 221, 223, which, in the particular embodiment shown, are optical fiber. In other embodiments, one or both of the waveguides 221, 223 may be waveguides formed on a substrate and the non-reciprocal phase shifter may be formed on the substrate also as an integrated optic device. Optical fiber 221 extends through a housing cap washer 225 to couple to collimator 229. Epoxy 231 is used to bond fiber 221 in place. Similarly, optical fiber 223 extends through housing cap washer 227 to couple to collimator 233. Epoxy 235 is used to bond fiber 223 in place. Boots 237, 239 are positioned on each housing cap washer 225, 227, respectively to support fibers 221, 223.

A ring shaped permanent magnet 241 is positioned concentric with crystal 215. A pair of ring shaped magnets 255, 257 are positioned on and longitudinally movable on tube 205. Magnets 255, 257 produce the same magnetic flux density, but are aligned to be of opposite magnetic polarity. Magnets 255,257 are movable from the position shown in FIG. 2 where magnet 255 is concentric with crystal 255 to a second position where Magnet 257 is concentric with crystal 213, and back to the first position. In the first position, magnet 255 causes crystal 213 to produce a predetermined Faraday rotation in one direction. In the second position, magnet 257 causes crystal 213 to produce a the predetermined Faraday rotation in the opposite direction. The advantage to this arrangement is that magnets 255, 257 may be moved by mechanical means such as pressurized air or vacuum in ports 261, 263 that are provided in housing 201. The magnetic positions are latching in both the first and second positions in that no continuous energy must be expended to maintain the magnets 255,257 in either the first or second position.

In operation, crystal 215 is fixed at a predetermined rotation angle and crystal 213 is switched from a second predetermined rotation angle to a third predetermined rotation angle to provide for switching of NRPS 200. In the illustrative embodiment of the invention, permanent magnet 241 biases crystal 115 to either +45 degrees or −45 degrees of rotation. Magnets 255, 257 are movable to switch the magnetic field at crystal 213 between two predetermined rotation angles of +45 degrees and −45 degrees. The combined result is that movement of magnets 255, 257 produces a cumulative phase shift in non-reciprocal phase shifter 200 that may, for example, be 0 or 90 degrees. Non-reciprocal phase shifter 200 is latchable in either state.

The non-reciprocal phase shifter 200 of FIG. 2 is also simply assembled, with construction similar to that of optical isolators. Advantageously, non-reciprocal phase shifter 200 provides low insertion loss of 1 dB or less, low cost and small size.

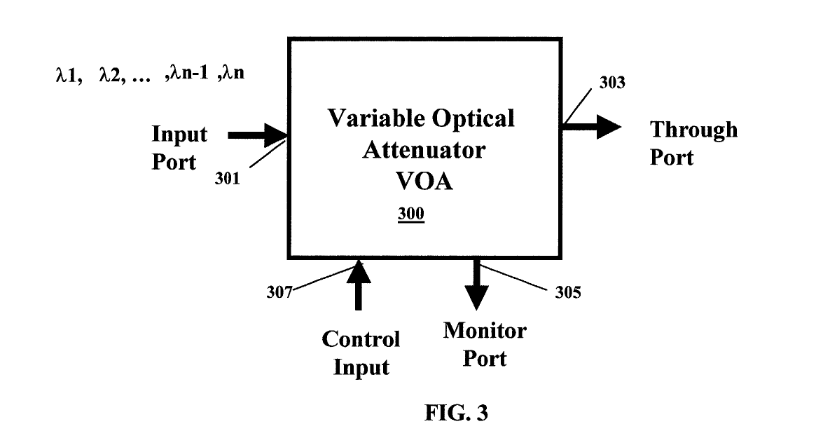

Turning now to FIG. 3, a variable optical attenuator 300 in accordance with the principles of the invention is shown in block form. Variable optical attenuator 300 includes an input port 301 that receives optical signals having a plurality of wave components λ1, λ2, . . . λn −1, λn. The output of variable optical attenuator 300 is provided at through port 303. In some instances, it is desirable to provide a monitor output. Monitor port 305 is provided for the monitoring function. In addition, a control input 307 is provided. Control input 307 is used to adjust the amount of attenuation/reflection provided by variable optical attenuator 300. The nature of control inputs provide at input 307 is dependant upon the type of non-reciprocal phase shifter employed in the variable optical attenuator 300. In embodiments of the variable optical attenuator 300 that utilize a non-reciprocal phase shifter such as the one shown in FIG. 1, the control input is an electrical input for receiving electrical control signals to operate the electromagnet. In embodiments of variable optical attenuator 300 that utilize a non-reciprocal phase shifter such as the one shown in FIG. 1, control inputs may be non-electrical controls.

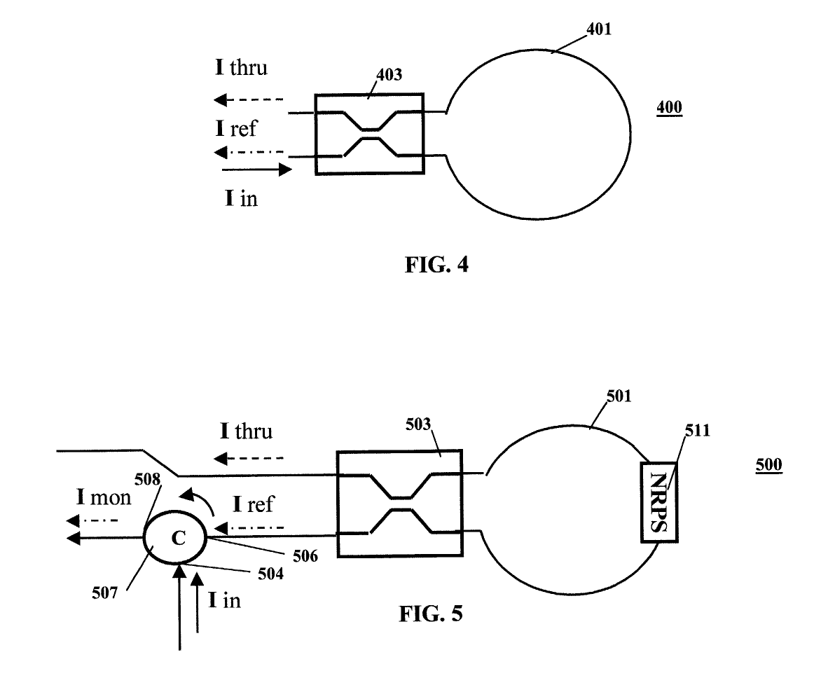

The variable optical attenuator/reflector of the invention is configured similarly to a Sagnac Interferometer. As shown in FIG. 4, a Sagnac interferometer 400 comprises a loop of optical fiber 401 and a 2 ×2 coupler 403. Coupler 403 is a 50%/50% coupler. If coupler 403 provides a perfect 50/50 split, 100% of the light is reflected back to the input as indicated by Iref, and the output or through signal Ithru is 0.

FIG. 4 illustrates a variable optical attenuator/reflector in a Sagnac interferometer configuration. Disposed in an optical fiber loop 501 is a non-reciprocal phase shifter 511. As in the configuration of FIG. 3, a coupler 503 is utilized. Coupler 503 is a 50/50 coupler. A circulator 507 is used to separate out a monitor signal Imon. Input signals are applied to input port 504 of circulator 507. Port 506 of circulator 507 is coupled to coupler 503. Port 508 is used to provide the output monitor signal. Circulator 507 is a three port circulator and the circulation direction is indicated by arrow 509. Non-reciprocal phase shifter 511 creates a +Φ phase shift for light propagating in a clockwise direction in loop 501 and a −Φ phase shift for counter-clockwise propagating light. The reflection rate depends on the power ratio between Ithru and Ilin, which in turn depends on the Φ phase shift produced by NRPS 51. For a phase shift of Φ=0°, Ithru =0% and Imon =100%. For a phase shift of Φ=45°, Ithru=50% and Imon =50%. For a phase shift of Φ=90°, Ithru =100% and Imon =0%.

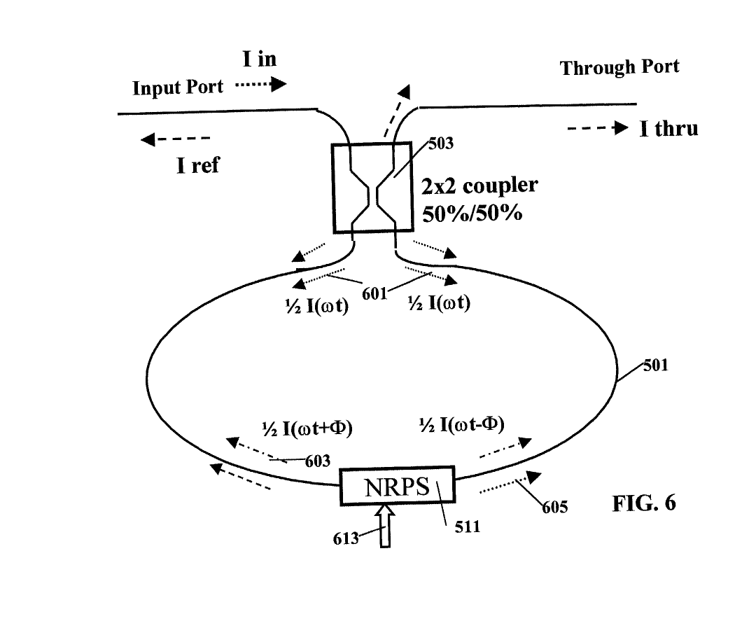

Turning now to FIG. 6, a the arrangement of FIG. 5 is shown without monitoring capability. The non-reciprocal phase shifter 511 is biased at 90° under normal conditions. The input signal Iin is equal to the summation of the through signal Ithru and the reflected signal Iref With a 50/50 coupler 503, ½ the input signal circulates in each direction of loop 502 as indicated by arrows 601. Arrows 603 indicate the direction of signals shifted by non-reciprocal phase shifter 511. Electrical control signals 613 input to non-reciprocal phase shifter 511 control the amount of Φ to determine the amount of reflection back to the input port and accordingly the amount of attenuation in the optical signals provided to the through port.

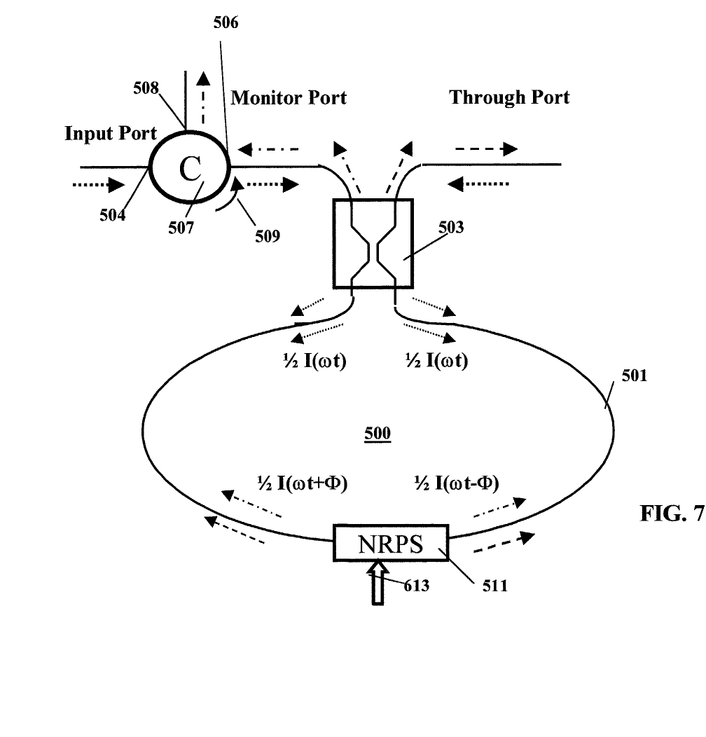

FIG. 7 illustrates the arrangement of FIG. 5 with the directions of optical signals and magnitudes. As with the arrangement shown in FIG. 6, non-reciprocal phase shifter 511 has control inputs 613 that permit varying the amount of phase shift in non-reciprocal phase shifter 511, and accordingly the amount of signal reflection back to circulator 507.

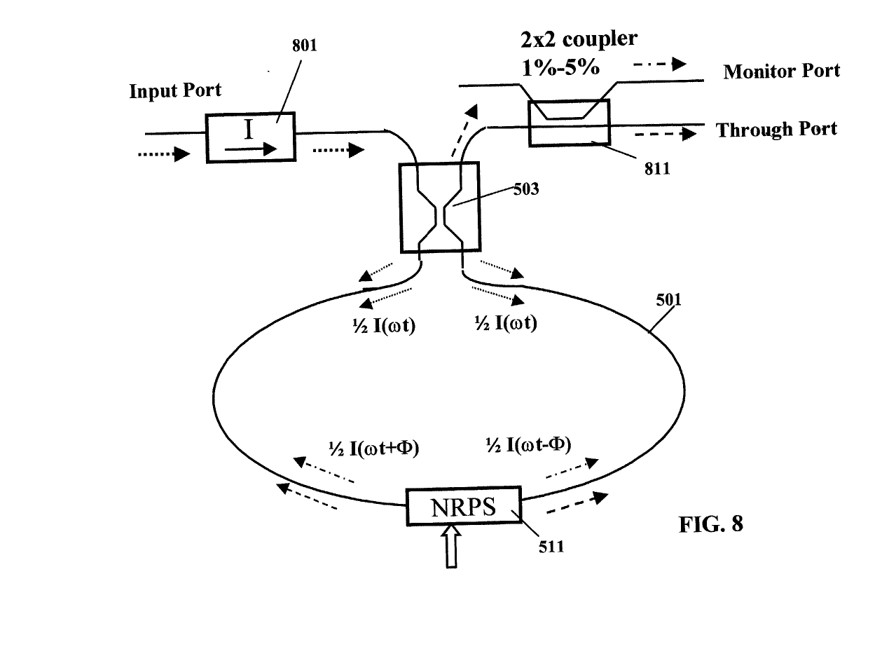

FIG. 8 shows an alternate arrangement in which only attenuated optical signals are provided. Isolator 801 prevents reflected signals from exiting at the input port. A second coupler 811 is utilized to provide a tap for monitor signals. Coupler 811, extracts a small amount of light, typically 1% to 5%. In all other respects, operation of the arrangement of FIG. 8 is the same as for the prior arrangements.

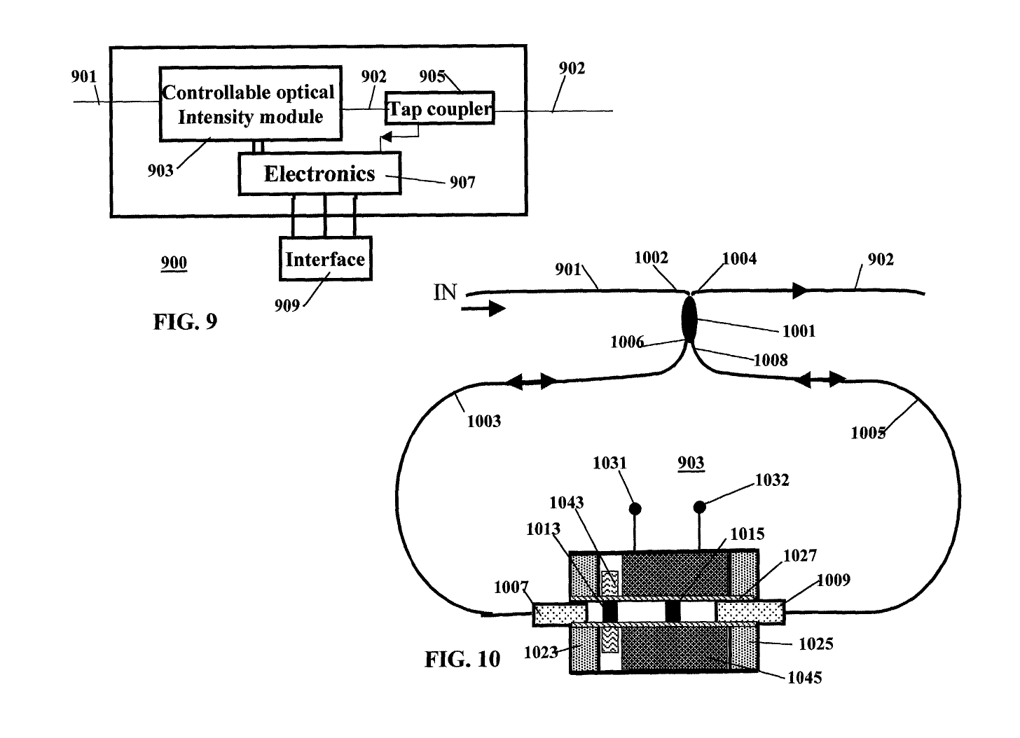

Turning now to FIG. 9, a variable optical attenuator 900 is utilized in an optical fiber system. Optical fibers 901, 902 connect variable optical attenuator 900 to the optical fiber system. Variable optical attenuator 900 includes a controllable optical intensity module 903, a tap coupler 905, control electronics 907 and an interface 909. Controllable optical intensity module 903 includes a broadband 2×2 splitter that splits the light into two equal parts, and a 0° to 90° adjustable non-reciprocal phase splitter (NRPS). Tap coupler 905 is coupled between the output of controllable optical intensity module 903 and optical fiber 902. Tap coupler 905 extracts a small amount, on the order of 1% to 2% of light from optical fiber 902. The tapped light is coupled to a detector in electronics control module 907. Electronics control module 909 provides a control current to controllable optical intensity module 903 to control the amount of attenuation. Interface module 909 is electronically coupled to electronics module 907. Interface module 907 sets the amount of light to be attenuated. Electronics control module 907 utilizes a look up table to determine the control current appropriate to produce the amount of attenuation. Tap coupler 905 provides a feed back signal to electronics control module 907 whereby electronics control module 907 can reach the exact desired level of attenuation. Electronics control module 907 may utilize a micro controller to provide the table look up and adjustment functionality for the controllable optical intensity module.

FIG. 10 illustrates the controllable optical intensity module 903 in greater detail. Input optical fiber 901 is coupled to one port 1002 of a splitter 1001. Output optical fiber 902 is coupled to a second port 1004 of splitter 1001. Splitter 1001 is a 50%/50% splitter and is of a type known in the art. The two other ports 1006, 1008 of splitter 1001 are coupled to a variable non-reciprocal phase shifter 1000.

Non-reciprocal phase shifter (NRPS) 1000 is shown in cross-section. Not shown in FIG. 10 is the housing or related support structure, it being understood by those skilled in the art that such details are not important to the present invention. Optical fibers 1003, 1005 couple splitter ports 1006, 1008 to NRPS 1000. NRPS 1000 includes an optical path coupling optical fibers 1003, 1005. The optical path includes a first collimator 1007 coupled to optical fiber 1003 and a second collimator 1009 coupled to optical fiber 1005. The optical path is provided by an aluminum tube. Two magneto-optic Faraday rotation devices 1013, 1015 are positioned within the optical path. Both magneto-optic Faraday rotation devices 1013, 1015 are thin film Bismuth Iron Garnet devices. A fixed or permanent magnet 1043 is disposed proximate crystal 1013. Fixed magnet 1043 is ring like in shape and is positioned concentric to crystal 1013. The magnetic field of fixed magnet 1043 as well as the thickness of crystal 1013 are selected to produce a magnetic field in crystal 1013 such that a predetermined Faraday rotation is provided. A controllable magnetic source is disposed proximate crystal 1015 to produce a controlled magnetic field in crystal 1015. The controlled magnetic field in the illustrative embodiment shown is switchable from a first flux level to a second flux level. Controlled magnetic source is an electromagnet 1045 having a solenoid coil positioned concentric to crystal 1015. Electromagnet 1045 has terminals 1031, 1032 that are connected to electronics control module 907. Electronics control module 907 provides operating current for the solenoid coil and thereby controls its operation. It will be understood by those skilled in the art that other apparatus may be employed to provide the controllable magnetic field for crystal 1015.

In operation, crystal 1013 is fixed at a predetermined Faraday rotation angle. The Faraday rotation angle of crystal 1015 is variable switchable from a second predetermined rotation angle to a third predetermined angle to provide for variable phase shifting in crystal 1015. The cumulative effect of the two Faraday rotation crystals produces a variable phase shift from a first predetermined level to a second predetermined level. In the illustrative embodiment of the invention, permanent magnet 1043 biases crystal 1013 to either +45 degrees or −45 degrees of rotation. Current in electromagnet 1045 is used to vary the Faraday rotation in crystal 105 between +45 degrees and −45 degrees. The combined result of the Faraday rotations in crystals 1013, 1015 is a phase shift that varies between 0 degrees to 90 degrees.

By utilizing a non-reciprocal phase shifter 1000 in combination with a splitter 1001, the intensity of output optical signals on optical fiber 902 can be varied from 0 to 100% of the input intensity on optical fiber 901.

The non-reciprocal phase shifter 1000 of FIG. 10 is simply assembled, with construction similar to that of optical isolators. The crystals are supported in and aluminum tube 1027 and aluminum washers 1023, 1025 are used to close off the ends of the device. Other packaging and support structures may be also used.

As will be appreciated by those skilled in the art, various modifications can be made to the embodiments shown in the various drawing figures and described above without departing from the spirit or scope of the invention. In addition, reference is made to various directions in the above description. It will be understood that the directional orientations are with reference to the particular drawing layout and are not intended to be limiting or restrictive. It is not intended that the invention be limited to the illustrative embodiments shown and described. It is intended that the invention be limited in scope only by the claims appended hereto.

What is claimed is:

1. A variable optical reflector/attenuator comprising:
an optical coupler having first, second, third and fourth ports, said first port receiving input optical signals, said fourth port providing output signals;
a loop of optical fiber coupled between said third and fourth ports;
a non-reciprocal phase shifter disposed in said loop, said non-reciprocal phase shifter being operable to provide a non-reciprocal phase shift variable from a first predetermined phase shift to a second predetermined phase shift, to control the amount of light received at said first port that is coupled to said output port and the amount of light reflected to said first port.

2. A variable optical reflector/isolator in accordance with claim 1, comprising
a circulator coupled to said first port to separate input signals from monitor signals.

3. A variable optical reflector/isolator in accordance with claim 1, comprising:
an isolator coupled to said first port, said input signals being coupled to said optical coupler through said isolator.

4. A variable optical reflector/isolator in accordance with claim 3, comprising:
a second coupler coupled to said fourth port for splitting output signals at said fourth port.

5. A variable optical reflector/isolator in accordance with claim 1, wherein:
said coupler is a 50%/50% coupler.
